(19) United States
(12) Patent Application Publication
(10) Pub. No.: US 2013/0304434 A1
(43) Pub. Date: Nov. 14, 2013

(54) COMPUTING SYSTEM WITH HIGH-THROUGHPUT TOPICAL ANALYSIS FOR SOLID STATE ELECTROLYTE MECHANISM AND METHOD OF OPERATION THEREOF

(71) Applicant: Samsung Electronics Co., Ltd., Gyeonggi-Do (KR)

(72) Inventors: Lincoln Miara, Cambridge, MA (US); Masoud Aryanpour, Malden, MA (US); Hyo Sug Lee, Yeongtong-gu (KR)

(73) Assignee: Samsung Electronics Co., Ltd., Gyeonggi-Do (KR)

(21) Appl. No.: 13/893,218

(22) Filed: May 13, 2013

Related U.S. Application Data
(60) Provisional application No. 61/646,157, filed on May 11, 2012.

(51) Int. Cl. G06F 17/50

(52) U.S. Cl. CPC G06F 17/5009
USPC 703/2

(57) ABSTRACT

A computing system includes: a voronoi tessellation formation module configured to form a voronoi tessellation for a solid separator; a modified tessellation generation module, coupled to the voronoi tessellation formation module, configured to: generate a modified tessellation by removing from the voronoi tessellation a node, an edge, or a combination thereof associated with a cation polygon except where the edge is less than an exception threshold, determine a channel dimensionality, a bottleneck size, a critical radius, or a combination thereof based on the modified tessellation; and a viability determination module, coupled to the modified tessellation generation module, configured to determine a viability of the solid separator based on the channel dimensionality, the bottleneck size, the critical radius, or a combination thereof.

### CROSS-REFERENCE TO RELATED APPLICATION(S)

This application claims the benefit of U.S. Provisional Patent Application Ser. No. 61/646,157 filed May 11, 2012, and the subject matter thereof is incorporated herein by reference thereto.

### TECHNICAL FIELD

An embodiment of the present invention relates generally to a computing system, and more particularly to a system for high-throughput topical analysis for solid state electrolyte.

### BACKGROUND

Modern consumer and industrial electronics, especially mobile devices such as computer tablets, smartphones, cellular phones, portable digital assistants, and combination devices, are providing increasing levels of functionality to support modern life with an ever-increasing need for battery power and battery life. Other devices are now also becoming more reliant on battery as the main or only source of power, such as hybrid or electric cars.

Research and development in the existing technologies can take a myriad of different directions including the type of electrolytes between an anode and a cathode of a battery. One research area is lithium ion batteries with solid state electrolyte or separator. Although solid state separators provide advantages compared to other battery technologies, they also present disadvantages.

Thus, a need still remains for a computing system with high-throughput topical analysis for solid state electrolyte mechanism for lithium ion batteries. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: a voronoi tessellation formation module configured to form a voronoi tessellation with a control unit for a solid separator; a modified tessellation generation module, coupled to the voronoi tessellation formation module, configured to: generate a modified tessellation by removing from the voronoi tessellation a node, an edge, or a combination thereof associated with a cation polygon except where the edge is less than an exception threshold, determine a channel dimensionality, a bottleneck size, a critical radius, or a combination thereof based on the modified tessellation; and a viability determination module, coupled to the modified tessellation formation module, configured to determine a viability of the solid separator based on the channel dimensionality, the bottleneck size, the critical radius, or a combination thereof.

An embodiment of the present invention provides a method of operation of a computing system including: forming a voronoi tessellation with a control unit for a solid separator; generating a modified tessellation by removing from the voronoi tessellation a node, an edge, or a combination thereof associated with a cation polygon except where the edge is less than an exception threshold; determining a channel dimensionality, a bottleneck size, a critical radius, or a combination thereof based on the modified tessellation; and determining a viability of the solid separator based on the channel dimensionality, the bottleneck size, the critical radius, or a combination thereof.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with high-throughput topical analysis for solid state electrolyte mechanism in an embodiment of the present invention.

FIG. 2 is an example schematic view of the battery.

FIG. 3 is an example of a voronoi tessellation.

FIG. 4 is an Arrhenius graph for an example of the solid separator.

FIG. 5 is a diffusivity graph and a bottleneck graph for examples of the solid separator.

FIG. 6 is a comparison with graphical representations of conduction paths with ab-initio molecular dynamics and topology analysis.

FIG. 7 is a graph representing effects of anions and cations on conductivity and bottleneck size.

FIG. 8 is a control flow of the computing system.

FIG. 9 is an exemplary block diagram of the computing system.

FIG. 10 is a flow chart of a method of operation of a computing system in an embodiment of the present invention.

### DETAILED DESCRIPTION

An embodiment of the present invention provides a topology analysis for identifying, selecting, and validating potential samples of a solid separator for use in a battery. Topology based on the modified tessellation from the voronoi tessellation for the solid separator is considered critical since no acceptable compounds have been found without a migration channel which shows good diffusivity. That means that finding a migration channel of at least dimension 2 is “critical” for a material to be considered for as an appropriate material for the solid separator, e.g. solid electrolyte. Channel dimension is a metric used for screening compounds.

An embodiment of the present invention provides a topology analysis with the modified tessellation can be used an iterative fashion to feed forward the selection of future samples. The geometries of the samples being analyzed can be determined to be viable or not based on the bottleneck size being too small compared to a minimum size for the particular battery ion for that specific solid separator. This information can be used to direct the selection of the next sample based on the change in anion from the previously analyzed samples or selection an anion with a size that can cause an expansion, as opposed to compression, to the structure of the previously analyzed sample.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. Where the embodiments have been numbered first embodiment, second embodiment, etc. as a matter of descriptive convenience and are not intended to have any other significance or provide limitations for an embodiment of the present invention.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

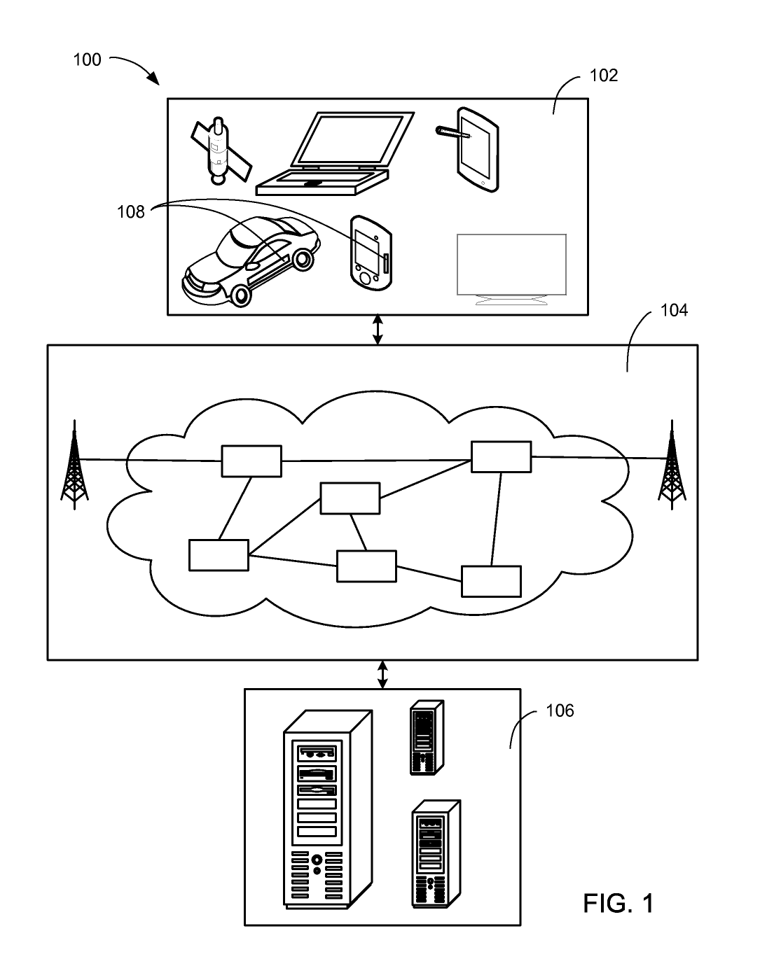

Referring now to FIG. 1, therein is shown a computing system 100 with high-throughput topical analysis for solid state electrolyte mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network. The first device 102 can couple, either directly or indirectly, to the communication path 104 to communicate with the second device 106 or can be a stand-alone device.

For example, the first device 102 can be of any of a variety of devices, such as a satellite, a vehicle, a computer table, a smartphone, a cellular phone, personal digital assistant, a notebook computer, or another multi-functional device. The first device 102 can be operated in part or entirely off of a battery 108. A battery 108 is a portable power supply. As an example, the battery 108 can be a secondary battery, which can be charged and recharged.

The second device 106 can be any of a variety of centralized or decentralized computing devices, or transmission devices. For example, the second device 106 can be a workstation computer, a laptop computer, a desktop computer, a grid-computing resource, a virtualized computer resource, cloud computing resource, routers, switches, peer-to-peer distributed computing devices, or a combination thereof.

The second device 106 can be centralized in a single room, distributed across different rooms, distributed across different geographical locations, embedded within a telecommunications network. The second device 106 can couple with the communication path 104 to communicate with the first device 102.

For illustrative purposes, the computing system 100 is described with the second device 106 as a computing device, although it is understood that the second device 106 can be different types of devices. Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

An embodiment of the present invention can operate on the second device 106, the first device 102, or distributed between the two. The operation of an embodiment of the present invention can also be distributed to other devices within the communication path 104. The second device 106 as well as elements in the communication path 104 can also be partly or entirely operate off of the battery 108.

The communication path 104 can span and represent or traverse a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

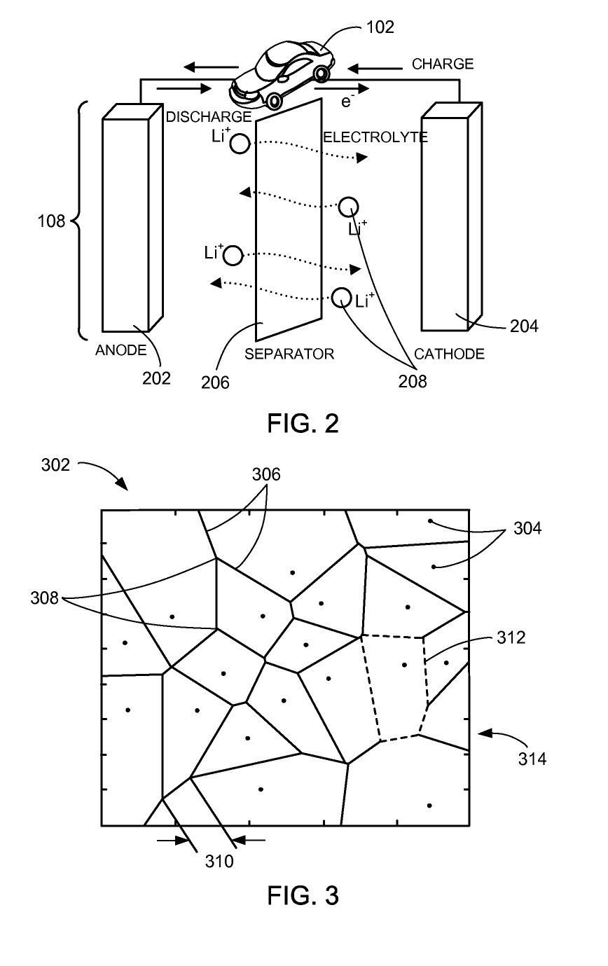

Referring now to FIG. 2, therein is shown an example schematic view of the battery 108. This example depicts one cell of potentially many cells in the battery 108. This example also depicts the first device 102 as a vehicle providing the external source for charging the battery 108 or the external load to discharge the battery 108. The vehicle can be a hybrid vehicle or an electric vehicle.

The schematic view conveys the battery 108 including an anode 202, a cathode 204, and a solid separator 206. The solid separator 206 conducts electricity through movement of battery ions 208 and is not a liquid solution. The solid separator 206 can also be referred to as a solid electrolyte. Examples of the solid separator 206 are solid ceramic or glassy ceramic lithium ion conductors. Other examples are gelled or wet polymers, solvent free polymers, inorganic crystalline compounds, and inorganic glasses.

During charging, the battery ions 208 move from the cathode 204 through the solid separator 206 to the anode 202. In the example shown in FIG. 2, the battery ions 208 are lithium ions. During discharging, the battery ions 208 move from the anode 202 through the solid separator 206 to the cathode 204.

The solid separator 206 provides numerous benefits such as a natural seal, resistance to shock and vibration, resistance to pressure and temperature variations, a wider electrochemical stability and better safety compared to liquid electrolytes. Generally, the identification and design of the solid separator 206 with high ionic conductivity with negligible electronic conductivity remains the goal. The embodiment of the present invention greatly simplifies and accelerates the identification of the solid separator 206 with the high ionic conductivity along with the other desirable attributes and features noted above.

Referring now to FIG. 3, therein is shown an example of a voronoi tessellation 302. FIG. 3 depicts the voronoi tessellation 302, as an example, for the solid separator 206 of FIG. 2. The specific depiction of the voronoi tessellation 302 varies based on the specific materials and structure or framework for the solid separator 206.

The voronoi tessellation 302 is shown with atoms 304 surrounded by edges 306 and the intercepts of the edges 306 are nodes 308. Each of the edges 306 can include an edge length 310.

The atoms 304 can be different atomic elements based on the material of the solid separator 206. For some of the atoms 304 that are cations, the edges 306 around the cation can be referred to as a cation polygon 312 or a cation framework.

A modified tessellation 314 can be generated from the voronoi tessellation 302 by removing some of the edges 306, the nodes 308, or a combination thereof based on some criteria, which will be discussed further later. The edges 306 that are removed are depicted as the dashed line segments.

For illustrative purposes, the voronoi tessellation 302 and the modified tessellation 314 is shown as two dimensional, although it is understood that the voronoi tessellation 302 and the modified tessellation 314 can be shown in a different configuration. For example, the voronoi tessellation 302 and the modified tessellation 314 can be shown to be three dimensional to better represent the solid structure of the material for the solid separator 206. The voronoi tessellation 302 and the modified tessellation 314 configuration can also differ depending on the lattice structure for the solid separator 206.

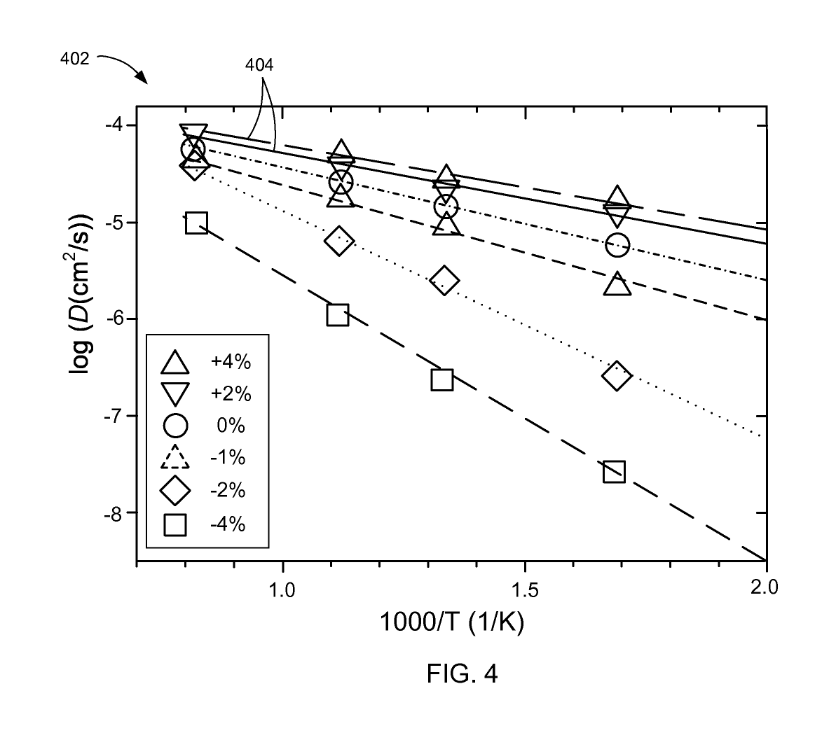

Referring now to FIG. 4, therein is shown an Arrhenius graph 402 for an example of the solid separator 206. The Arrhenius graph 402 depicts plots 404 for diffusivity for one example of the solid separator 206, lithium superionic conductor Li₁₀GeP₂S₁₂ (LGPS), and calculated by ab-initio molecular dynamics at different temperatures with the lattice parameter changed as indicated in the legend of the Arrhenius graph 402. Compression of the lattice of the solid separator 206 retards diffusion whereas expansion allows a more free movement of the battery ions 208 of FIG. 2.

The plots in FIG. 4 show directly that in fact the battery ions 208, in this example lithium, moves along the geometrically identified migration pathway. Unlike electronic conduction, as an example used in complementary metal-oxide-semiconductor (CMOS) chips, is well known, but the exact connection between ionic conduction and topology is not well understood before the embodiment of the present invention.

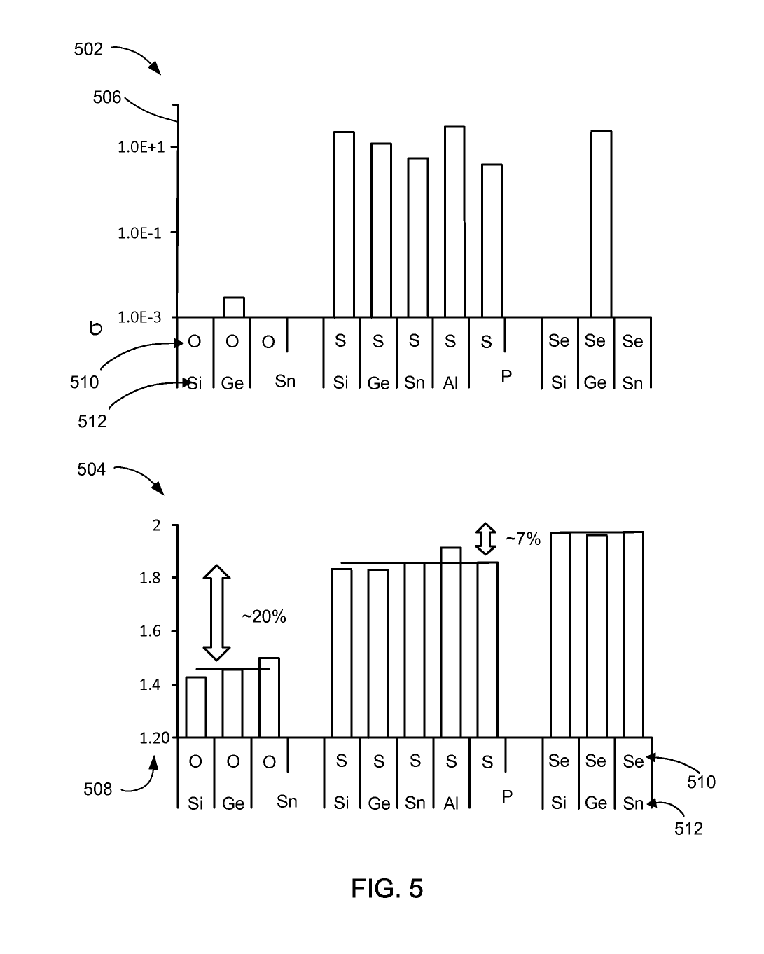

Referring now to FIG. 5, therein is shown a diffusivity graph 502 and a bottleneck graph 504 for examples of the solid separator 206. The diffusivity graph 502 and the bottleneck graph 504 is for the example of the solid separator 206 of Li_{10±1}MP₂X₁₂ (M=Ge, Si, Sn, Al or P, and X=O, S or Se).

For the diffusivity graph 502, the y-axis is for diffusivity 506 for particular selections for the solid separator 206 from Li_{10±1}SiP₂O₁₂ to Li_{10±1}SnP₂Se₁₂ along the x-axis. For the bottleneck graph 504, the y-axis is for a bottleneck size 508 for the same selections for the solid separator 206 also from Li_{10±1}SiP₂O₁₂ to Li_{10±1}SnP₂Se₁₂ along the x-axis. For both the diffusivity graph 502 and the bottleneck graph 504, the top row of symbols along the x-axis represents “X” and the lower row of symbols represents “M” in Li_{10±1}MP₂X₁₂.

In the past, it has been conjectured that the bottleneck size 508 is important to diffusion. The results depicted in FIG. 4 along with the bottleneck graph 504 suggest that the conductivity, which is related to diffusivity, correlates with the bottleneck size 508. In particular, the decrease in conductivity correlates with a decrease in the bottleneck size 508 for each of the examples of the solid separator 206 shown in FIG. 5.

FIG. 5 shows the comparison between conductivity and the bottleneck size 508 for different compositions of Li_{10±1}MP₂X₁₂ (M=Ge, Si, Sn, Al or P, and X=O, S or Se). The comparison indicates that the bottleneck size 508 and the conductivity changes much more with changes with anions 510 (O for S substitution) than substitutions for cation 512 (e.g. Al for Ge substitution). In other words, this comparison indicates the cations 512 are much less important to overall diffusivity than the topology of the structure for the solid separator 206. The cations 512 can be one of the atoms 304 of FIG. 3.

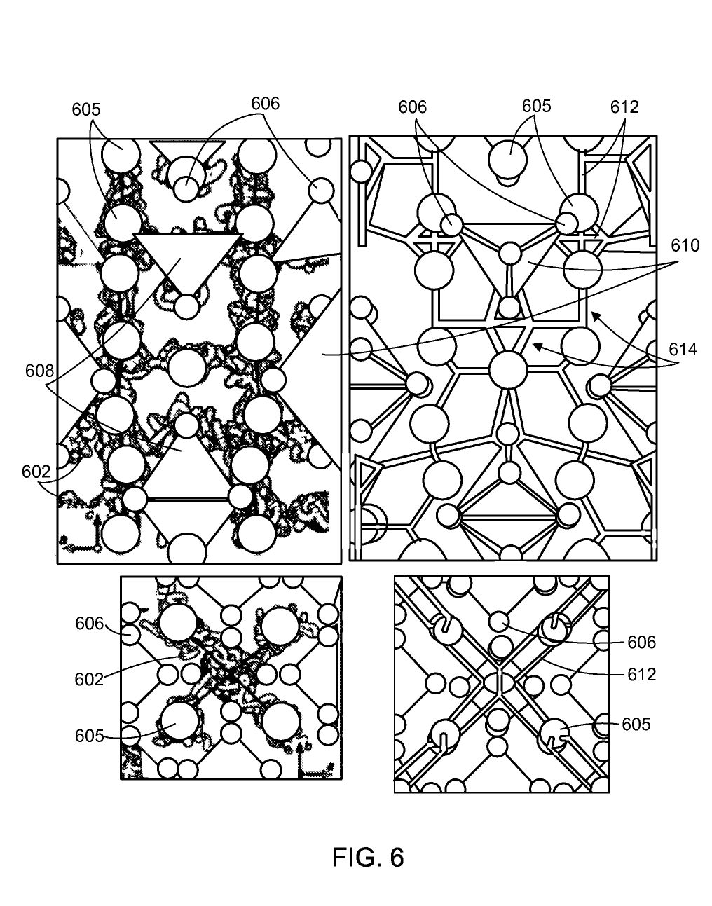

Referring now to FIG. 6, therein is shown a comparison with graphical representations of conduction paths 602 with ab-initio molecular dynamics and topology analysis. FIG. 6 depicts the example for the solid separator 206 of FIG. 2 with lithium atoms 605 for the sulfur 606, phosphorous tetrahedral 608, germanium tetrahedral 610. The lithium atoms 605 can be one of the atoms 304 of FIG. 3.

One of the challenges for identifying, selecting, and validating the materials for the solid separator 206 is the complexity of simulation for the materials using existing simulation techniques such as ab-initio molecular dynamics. Topology analysis in the embodiment of the present invention uses the modified tessellation 314 of FIG. 3 and immensely reduces the computational complexity and increases the throughput of identification, selection, and validation of the materials by simplifying the problem by using the results discussed above. In other words, the key observations regarding the correlation between the conductivity and the bottleneck size 508 along with the importance of the anions 510 over the cations 512 to the overall diffusivity resulted in the simplification details required for the simulations with ab-initio molecular dynamics to those required for the topology analysis approach.

The two left-side pictures in FIG. 6 depict different views of the solid separator 206 with the ab-initio molecular dynamics. The two right-side figures in FIG. 6 depict the same views as the left-side but with topology analysis.

The two left-side pictures also depict the complex conduction paths 602 representing the positions of the lithium atoms 605 over the time course of the ab-initio molecular dynamics simulation. Each one of the complex conduction paths 602 is a location of the lithium atoms 605 at a time step during the simulation. Together they make the “trajectory” of the lithium atoms 605 during the course of the simulation.

The two right-side pictures represents the topology analysis of the modified tessellation 314 with the cation polygon 312 of FIG. 3 removed motivated by the observations discussed earlier. Conduction channels 612 are shown and are the edges 306 of FIG. 3 remaining in the modified tessellation 314. The conduction channels 612 are connected to provide the conduction path for the lithium atoms 605 and represent the conduction paths through the structure or framework of the solid separator 206 having a space large enough for the lithium atoms 605 to pass. The conduction channels 612 in the modified tessellation 314 is the first demonstrated evidence and discovery that topology of the solid separator 206 is critical to the lithium atoms 605 migration and the conduction channels 612 identified in the modified tessellation 314 are indeed the low energy migration channels for conduction.

The conduction channels 612 depicted along different axes on the top and bottom right-side pictures depict a channel dimensionality 614 of three dimension through the structure or framework of the solid separator 206. The identification of the channel dimensionality 614 to be three dimensional was not previously discovered.

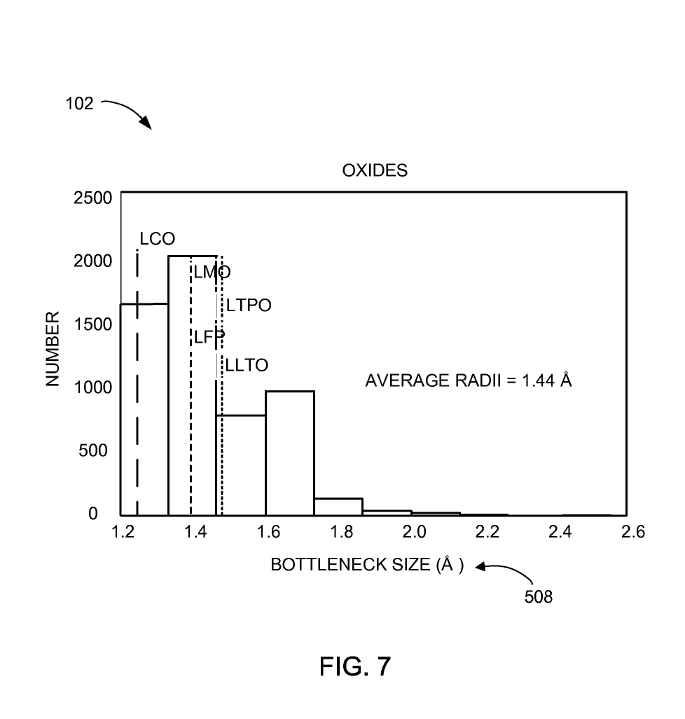

Referring now to FIG. 7, therein is shown a graph representing effects of the anions 510 and the cations 512 on conductivity and the bottleneck size 508. The y-axis represents the number of samples or examples of the solid separator 206 being analyzed and the x-axis represent the bottleneck size 508 for the samples being analyzed.

The computing system 100 performs the topology analysis with the modified tessellation 314 on all known lithium containing compounds, as examples of the solid separator 206. The identification criteria were to find the conduction channels 612 of FIG. 6 large enough for the lithium atoms 605 of FIG. 6 to pass through the conduction channels 612 of FIG. 6 having the channel dimensionality 614 of FIG. 6 of two dimension or three dimension.

The examples were then sorted by the bottleneck size 508, the biggest probe which could pass through any dimension channel. Of the more than 50,000 lithium oxide compounds, about 5600 compounds were identified as possible conductors or possible materials for the solid separator 206. The list of examples included all of the previously identified conductors, as well as many new materials that have not been fully vetted.

FIG. 7 depicts a histogram of the results from oxide compounds with several materials labeled. The size of 1.2 A is the approximate size of the lithium atoms 605 of FIG. 6, or more specifically a lithium ion, in an oxygen environment. The known good conducting materials: lithium lanthanum titanate (LLTO) and the NASICON type lithium titanium phosphate (LTPO) have relatively large bottleneck compared to known poor conductors such as LiCoO₂ (LCO) and LiMn₂O₄, in further support of the topology analysis with the modified tessellation 314 of FIG. 3.

FIG. 7 demonstrates the power of this technique using the topology analysis with the modified tessellation 314 to screen thousands of compounds very quickly and to provide information about them (in this example, the bottleneck size 508). FIG. 7 also shows that there are very few compounds with a large bottleneck size (i.e. >1.7 Å) and the size of the bottleneck roughly correlates with the conductivity of some known compounds annotated on the graph.

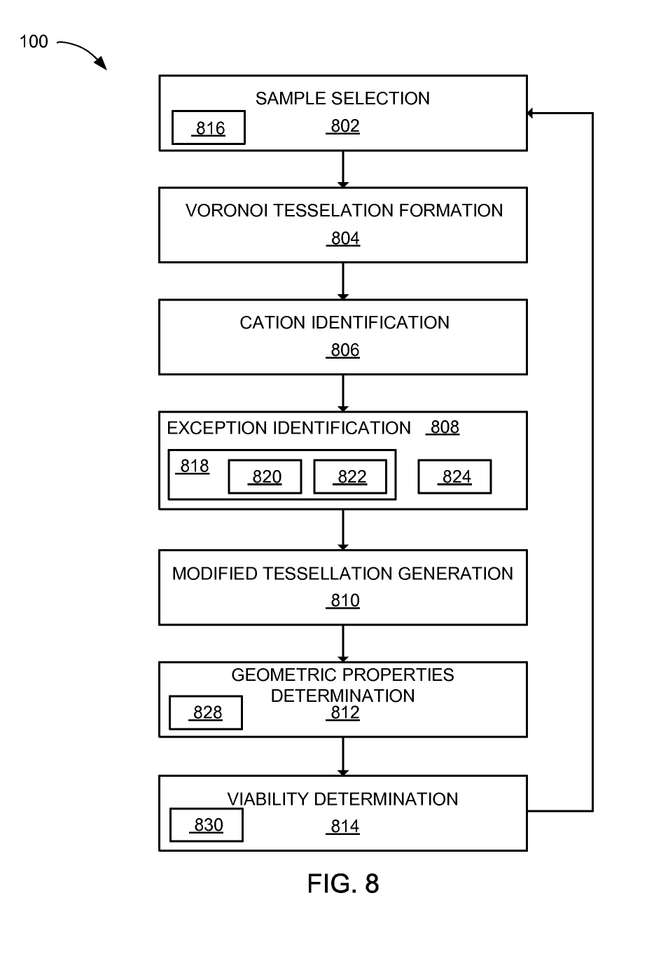

Referring now to FIG. 8, therein is shown a control flow of the computing system 100. The computing system 100 can include a sample selection module 802, a voronoi tessellation formation module 804, a cation identification module 806, an exception identification module 808, a modified tessellation generation module 810, geometric properties determination module 812, and a viability determination module 814.

The order of operation of the control flow can be as shown in the figure or as described in this application. The order of operation is exemplary as is the partition of the modules. The control flow can be operate in a different configuration or order, such as not linear and can include loop backs or iterations.

The sample selection module 802 selects a sample 816 for the solid separator 206 of FIG. 2 to be analyzed by the topology analysis in the embodiment of the present invention. The selection can be a search through a database of possible compounds to be considered or specifically provided for analysis. The control flow can proceed from the sample selection module 802 to the voronoi tessellation formation module 804. The preceding figures describe a number of examples for the sample 816.

The voronoi tessellation formation module 804 forms or generates the voronoi tessellation 302 of FIG. 3 or a voronoi network diagram for the sample 816. This module analyzes the structure and the framework of the sample to form the voronoi tessellation 302 based on the atoms 304 of FIG. 3. The voronoi tessellation 302 includes the edges 306 of FIG. 3 and the nodes 308 of FIG. 3. The control flow can proceed from the voronoi tessellation formation module 804 to the cation identification module 806.

The cation identification module 806 identifies the cations 512 of FIG. 5 or the cation polygon 312 of FIG. 3 in the voronoi tessellation 302. The identification of the cation polygon 312 varies depending on the composition of the sample 816. The control flow can proceed from the cation identification module 806 to the exception identification module 808.

The exception identification module 808 identifies the edges 306 associated with the cation polygon 312 as exceptions from removal. The edges 306, as the exceptions, can be identified by an exception threshold 818. The exception threshold 818 is used for comparison to determine what action should be takes with the edges 306 associated with the cation polygon 312.

The exception threshold 818 can include a distance threshold 820 and an angle threshold 822. The distance threshold 820 is used for comparison with the edge length 310 of FIG. 3 to determine what action should be taken with that particular instance of the edges 306. The angle threshold 822 is used for comparison with a solid angle 824 to determine what action should be taken with the edges 306 where the angle is calculated is taken.

For example, if the edge length 310 is less than the distance threshold 820, then that particular instance of the edges 306 is not subject to removal or remains as part of the modified tessellation 314 despite the fact that it is associated with the cation polygon 312. An example value for the distance threshold 820 can be 0.15 angstroms as for some of the examples of the solid separator 206 discussed in the previous figures. The value of the distance threshold 820 can vary depending on the material or structure or framework of the solid separator 206. The distance threshold 820 can be based on some percentage, for example 10%, of lattice parameters for the solid separator 206.

Also for example, if the solid angle 824 is less than the angle threshold 822, then that particular instance of the edges 306 or the surface associated with the cation polygon 312 would remain in the modified tessellation 314. Otherwise it would be removed from the modified tessellation 314. The angle threshold 822 can be determined by a percentage of the surface being associated with the cation polygon 312. An example value for the angle threshold 822 can be 10%. The control flow can proceed from the exception identification module 808 to the modified tessellation generation module 810.

The modified tessellation generation module 810 provides a version of the voronoi tessellation 302 for the topology analysis of the solid separator 206. The modified tessellation generation module 810 removes the edges 306 and the nodes 308 associated with the cation polygon 312 identified by the cation identification module 806. The exceptions to removal are those identified by the exception identification module 808 such that those instances of the edges 306 and the nodes 308 remain as part of the modified tessellation 314 even though they are associated with the cation polygon 312

It has been discovered that the embodiment of the present invention provides a more accurate topology analysis results because it eliminates inconsistent results between compounds of similar structures. The exception threshold 818 is used for comparison in order to keep certain instances of the edges 306 and the nodes 308 in the modified tessellation 314 to provide the more accurate results. As an example, without the exception identification, two very closely related structures (i.e., LiFePO₄ and NaFePO₄) would behave differently due to minor distortions in the crystal structure.

The control flow can proceed from the modified tessellation generation module 810 to the geometric properties determination module 812. The geometric properties determination module 812 calculates the channel dimensionality 614 of FIG. 6 and the bottleneck size 508 of FIG. 5 associated with the sample 816 of the solid separator 206 based on the modified tessellation 314. The geometric properties determination module 812 identifies the conduction channels 612 from the edges 306 remaining in the modified tessellation 314. The geometric properties determination module 812 determines a critical radius 828, R_{c}, which is the radius at which a three dimensional or two dimensional conductor or the conduction channels 612 becomes a one dimensional conductor and is no longer of importance because the ionic conductivity becomes too low to be viable.

The control flow can proceed from the geometric properties determination module 812 to the viability determination module 814. The viability determination module 814 determines the viable of the sample 816 for the solid separator 206 for commercial use in the battery 108 of FIG. 2. This determination is made on the channel dimensionality 614 to be at least two dimension and preferably three dimension based on the critical radius 828. Another factor to determine viability is the bottleneck size 508 relative to the size of the battery ions 208 that will be the conductor for the solid separator 206. The bottleneck size 508 can be compared to a minimum size 830, which is determined by the size of the battery ions 208 used for ionic conductivity for the solid separator 206. An example of the result from this module can be described in FIG. 7.

If the viability determination module 814 determines the sample 816 to have the bottleneck size 508 to be below the minimum size 830, the control flow can proceed back to the sample selection module 802. Based on the discussion in FIG. 5, another instance of the sample 816 for the solid separator 206 can be selected with a change in one or more of the anions 510 in the chemical formula from the sample 816 previously analyzed. As discussed in FIG. 5, the change in one or more of the anions 510 in a chemical formula can most effect the bottleneck size 508, the conductivity, or a combination thereof. This can be used to provide a direction of which compounds to select based on the learning of past samples analyzed. In addition, the size of the anions 510 can be used to estimate or predict a compression or expansion effect from the sample 816 previously analyzed to again provide a direction of which compounds to selection for analysis.

As an example, some of the modules can be implemented with the Zeo++ software platform. The current Zeo++ is only concerned with finding void space in a crystal structure, and was unconcerned with how that space arises. The current Zeo++ is interested in finding materials which can accommodate un-charged gases such as oxygen or methane.

In the case of Li ion migration, the solid separator 206 have a moving charged (Li+) ion. Thus, because of electrostatic interactions, it can only move within a negatively charged framework made of the anions 510 (i.e., O²⁻, S²⁻, Se²⁻, or F⁻, Cl⁻, Br⁻, I⁻, etc.).

To add this to Zeo++, the embodiment of the present invention added the modules and functionality for anion channel which processes all the nodes 308 and the edges 306 from the voronoi tessellation 302 and removes those associated with at least one framework cation or described as the cation polygon 312 earlier. For example, in LiCoO₂ if a polygon has edges associated with at least one Co then that edge is rejected. The modified tessellation 314 can then be processed within Zeo++ platform to find any channels, the bottleneck size 508, etc.

In addition, the embodiment of the present invention also includes wrapper (not shown) to call the Zeo++ functions to make the process automated. The wrapper allows a selection of a structure or the sample 816 from a database and return the results from Zeo++. The wrapper removes the Lithium from the structure, creates an input file to Zeo++, processes the results and return them in human readable form, or it can be visualized with third party crystal structure viewing software such as JMOL, VMD, or VESTA.

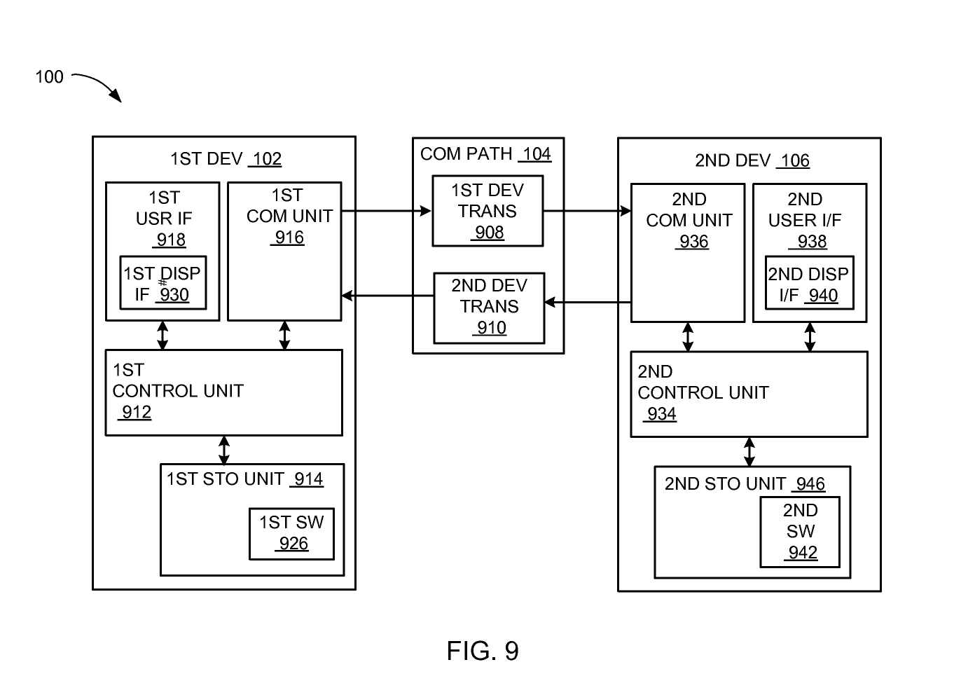

Referring now to FIG. 9, therein is shown an exemplary block diagram of the computing system 100. The computing system 100 can include the first device 102, the communication path 104, and the second device 106. The first device 102 can send information in a first device transmission 908 over the communication path 104 to the second device 106. The second device 106 can send information in a second device transmission 910 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

The first device 102 can include a first control unit 912, a first storage unit 914, a first communication unit 916, and a first user interface 918. The first control unit 912 can execute a first software 926 to provide the intelligence of the computing system 100.

The first control unit 912 can be implemented in a number of different manners. For example, the first control unit 912 can be a processor, an application specific integrated circuit (ASIC) an embedded processor, a microprocessor, a hardware control logic, a hardware finite state machine (FSM), a digital signal processor (DSP), or a combination thereof. The first control unit 912 can communicate with other functional units in and external to the first device 102. The external sources and the external destinations refer to sources and destinations external to the first device 102.

The first storage unit 914 can store the first software 926. The first storage unit 914 can also store the relevant information, such as data representing the solid separator 206.

The first storage unit 914 can be a volatile memory, a nonvolatile memory, an internal memory, an external memory, or a combination thereof. For example, the first storage unit 914 can be a nonvolatile storage such as non-volatile random access memory (NVRAM), Flash memory, disk storage, or a volatile storage such as static random access memory (SRAM). The first storage unit 914 can communicate between and other functional units in or external to the first device 102.

The first communication unit 916 can enable external communication to and from the first device 102. For example, the first communication unit 916 can permit the first device 102 to communicate with the second device 106 of FIG. 1, an attachment, such as a peripheral device or a computer desktop, and the communication path 104.

The first communication unit 916 can also function as a communication hub allowing the first device 102 to function as part of the communication path 104 and not limited to be an end point or terminal unit to the communication path 104. The first communication unit 916 can include active and passive components, such as microelectronics or an antenna, for interaction with the communication path 104. The first communication unit 916 can communicate with other functional units in and external to the first device 102.

The first user interface 918 allows a user (not shown) to interface and interact with the first device 102. The first user interface 918 can include an input device and an output device. Examples of the input device of the first user interface 918 can include a keypad, a touchpad, soft-keys, a keyboard, a microphone, an infrared sensor for receiving remote signals, or any combination thereof to provide data and communication inputs.

The first user interface 918 can include a first display interface 930. The first display interface 930 can include a display, a projector, a video screen, a speaker, or any combination thereof.

The first control unit 912 can operate the first user interface 918 to display information generated by the computing system 100. The first control unit 912 can also execute the first software 926 for the other functions of the computing system 100. The first control unit 912 can further execute the first software 926 for interaction with the communication path 104 via the first communication unit 916.

The second device 106 can be optimized for implementing an embodiment of the present invention in a multiple device embodiment with the first device 102. The second device 106 can provide the additional or higher performance processing power compared to the first device 102. The second device 106 can include a second control unit 934, a second communication unit 936, and a second user interface 938.

The second user interface 938 allows a user (not shown) to interface and interact with the second device 106. The second user interface 938 can include an input device and an output device. Examples of the input device of the second user interface 938 can include a keypad, a touchpad, soft-keys, a keyboard, a microphone, or any combination thereof to provide data and communication inputs. Examples of the output device of the second user interface 938 can include a second display interface 940. The second display interface 940 can include a display, a projector, a video screen, a speaker, or any combination thereof.

The second control unit 934 can execute a second software 942 to provide the intelligence of the second device 106 of the computing system 100. The second software 942 can operate in conjunction with the first software 926. The second control unit 934 can provide additional performance compared to the first control unit 912.

The second control unit 934 can operate the second user interface 938 to display information. The second control unit 934 can also execute the second software 942 for the other functions of the computing system 100, including operating the second communication unit 936 to communicate with the first device 102 over the communication path 104.

The second control unit 934 can be implemented in a number of different manners. For example, the second control unit 934 can be a processor, an embedded processor, a microprocessor, hardware control logic, a hardware finite state machine (FSM), a digital signal processor (DSP), or a combination thereof. The second control unit 934 can communicate with other functional units in and external to the second device 106.

A second storage unit 946 can store the second software 942. The second storage unit 946 can also store the information, such as data representing the solid separator 206. The second storage unit 946 can be sized to provide the additional storage capacity to supplement the first storage unit 914.

For illustrative purposes, the second storage unit 946 is shown as a single element, although it is understood that the second storage unit 946 can be a distribution of storage elements. Also for illustrative purposes, the computing system 100 is shown with the second storage unit 946 as a single hierarchy storage system, although it is understood that the computing system 100 can have the second storage unit 946 in a different configuration. For example, the second storage unit 946 can be formed with different storage technologies forming a memory hierarchal system including different levels of caching, main memory, rotating media, or off-line storage.

The second storage unit 946 can be a volatile memory, a nonvolatile memory, an internal memory, an external memory, or a combination thereof. For example, the second storage unit 946 can be a nonvolatile storage such as non-volatile random access memory (NVRAM), Flash memory, disk storage, or a volatile storage such as static random access memory (SRAM). The second storage unit 946 can communicate with other functional units in or external to the second device 106.

The second communication unit 936 can enable external communication to and from the second device 106. For example, the second communication unit 936 can permit the second device 106 to communicate with the first device 102 over the communication path 104.

The second communication unit 936 can also function as a communication hub allowing the second device 106 to function as part of the communication path 104 and not limited to be an end point or terminal unit to the communication path 104. The second communication unit 936 can include active and passive components, such as microelectronics or an antenna, for interaction with the communication path 104. The second communication unit 936 can communicate with other functional units in and external to the second device 106.

The first communication unit 916 can couple with the communication path 104 to send information to the second device 106 in the first device transmission 908. The second device 106 can receive information in the second communication unit 936 from the first device transmission 908 of the communication path 104.

The second communication unit 936 can couple with the communication path 104 to send information to the first device 102 in the second device transmission 910. The first device 102 can receive information in the first communication unit 916 from the second device transmission 910 of the communication path 104. The computing system 100 can be executed by the first control unit 912, the second control unit 934, or a combination thereof. For illustrative purposes, the second device 106 is shown with the partition having the second user interface 938, the second storage unit 946, the second control unit 934, and the second communication unit 936, although it is understood that the second device 106 can have a different partition. For example, the second software 942 can be partitioned differently such that some or all of its function can be in the second control unit 934 and the second communication unit 936. Also, the second device 106 can include other functional units not shown in FIG. 9 for clarity.

For illustrative purposes, the computing system 100 is described by operation of the first device 102 and the second device 106. It is understood that the first device 102 and the second device 106 can operate any of the modules and functions of the computing system 100.

The computing system 100 has been described with module functions or order as an example. The computing system 100 can partition the modules differently or order the modules differently. For example, cation identification module 806 of FIG. 8 can be part of the voronoi tessellation formation module 804 of FIG. 8.

The modules described in this application can be hardware implementation or hardware accelerators or hardware circuitry in the first control unit 316 of FIG. 3 or in the second control unit 338 of FIG. 3. The modules can also be hardware implementation or hardware accelerators or hardware circuitry within the first device 102 or the second device 106 but outside of the first control unit 316 or the second control unit 338, respectively.

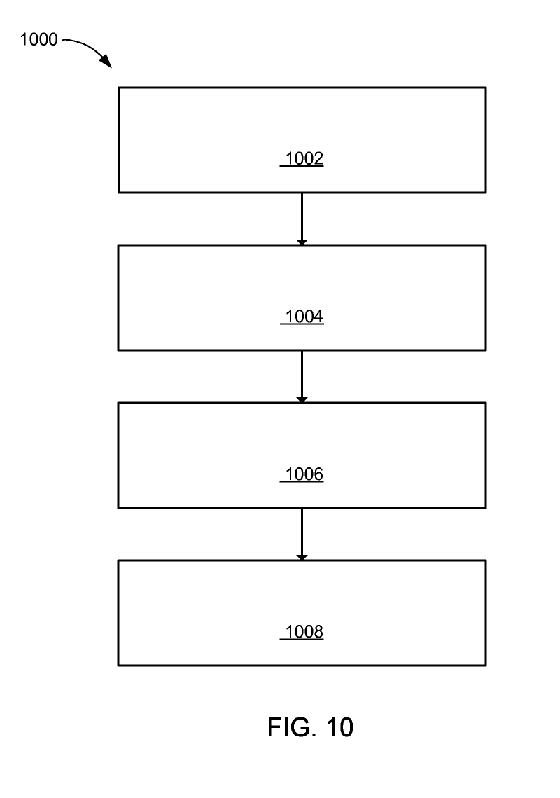

Referring now to FIG. 10, therein is shown a flow chart of a method 1000 of operation of a computing system 100 in an embodiment of the present invention. The method 1000 includes: forming a voronoi tessellation with a control unit for a solid separator in a block 1002; generating a modified tessellation by removing from the voronoi tessellation a node, an edge, or a combination thereof associated with a cation polygon except where the edge is less than an exception threshold in a block 1004; determining a channel dimensionality, a bottleneck size, a critical radius, or a combination thereof based on the modified tessellation in a block 1006; and determining a viability of the solid separator based on the channel dimensionality, the bottleneck size, the critical radius, or a combination thereof for displaying on a device in a block 1008.

It has been discovered that the topology analysis with the modified tessellation can be used an iterative fashion to feed forward the selection of future samples. The geometries of the samples being analyzed can be determined to be viable or not based on the bottleneck size being too small compared to a minimum size for the particular battery ion for that specific solid separator. This information can be used to direct the selection of the next sample based on the change in anion from the previously analyzed samples or selection an anion with a size that can cause an expansion, as opposed to compression, to the structure of the previously analyzed sample.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a voronoi tessellation formation module configured to form a voronoi tessellation for a solid separator;
a modified tessellation generation module, coupled to the voronoi tessellation formation module, configured to:
generate a modified tessellation by removing from the voronoi tessellation a node, an edge, or a combination thereof associated with a cation polygon except where the edge is less than an exception threshold,
determine a channel dimensionality, a bottleneck size, a critical radius, or a combination thereof based on the modified tessellation; and
a viability determination module, coupled to the modified tessellation generation module, configured to determine a viability of the solid separator based on the channel dimensionality, the bottleneck size, the critical radius, or a combination thereof.

2. The system as claimed in claim 1 wherein further comprising a geometric properties determination module, coupled to the modified tessellation generation module, configured to identify a conduction channel in the modified tessellation based on the remaining edges.

3. The system as claimed in claim 1 wherein the modified tessellation generation module is configured to remove the edge having a length greater than a distance threshold.

4. The system as claimed in claim 1 further comprising:
a geometric properties determination module, coupled to the modified tessellation generation module, configured to determine the critical radius from the modified tessellation; and
wherein:
the viability determination module is configured to determine the viability based on the critical radius.

5. The system as claimed in claim 1 wherein:
the viability determination module is configured to determine a sample of the solid separator based on the bottleneck size being below a minimum size; and
further comprising:
a sample selection module, coupled to the viability determination module, configured to select another sample for the solid separator with a similar formula to the sample with an anion replaced.

6. The system as claimed in claim 1 wherein:
the viability determination module is configured to determine a sample of the solid separator based on the bottleneck size being below a minimum size; and
further comprising:
a sample selection module, coupled to the viability determination module, configured to select another sample for the solid separator with a similar formula to the sample with an anion replaced and an expansion effect compared to the sample.

7. The system as claimed in claim 1 wherein the modified tessellation generation module is configured to remove the edge having a length greater than an angle threshold.

8. The system as claimed in claim 1 wherein the viability determination module is configured to determine the bottleneck size above a minimum size for allowing conduction of a battery ion.

9. The system as claimed in claim 1 wherein the viability determination module is configured to determine the channel dimensionality of at least 2 for allowing conduction of a battery ion.

10. The system as claimed in claim 1 wherein the modified tessellation generation module is configured to remove the edge having a length greater than the distance threshold of 0.15 angstrom.

11. A method of operation of a computing system comprising:
forming a voronoi tessellation with a control unit for a solid separator;
generating a modified tessellation by removing from the voronoi tessellation a node, an edge, or a combination thereof associated with a cation polygon except where the edge is less than an exception threshold;
determining a channel dimensionality, a bottleneck size, a critical radius, or a combination thereof based on the modified tessellation; and
determining a viability of the solid separator based on the channel dimensionality, the bottleneck size, the critical radius, or a combination thereof.

12. The method as claimed in claim 11 further comprising identifying a conduction channel in the modified tessellation based on the remaining edges.

13. The method as claimed in claim 11 wherein generating the modified tessellation by removing the edge except where the edge is less than the exception threshold include removing the edge having a length greater than a distance threshold.

14. The method as claimed in claim 11 further comprising:
determining the critical radius from the modified tessellation; and
wherein:
determining the viability of the solid separator includes determining the viability based on the critical radius.

15. The method as claimed in claim 11 wherein:
determining the viability of the solid separator includes determining a sample of the solid separator based on the bottleneck size being below a minimum size; and
selecting another sample for the solid separator with a similar formula to the sample with an anion replaced.

16. The method as claimed in claim 11 wherein:
determining the viability of the solid separator includes determining a sample of the solid separator based on the bottleneck size being below a minimum size; and
selecting another sample for the solid separator with a similar formula to the sample with an anion replaced and an expansion effect compared to the sample.

17. The method as claimed in claim 11 wherein generating the modified tessellation by removing the edge except where the edge is less than the exception threshold include removing the edge having a length greater than an angle threshold.

18. The method as claimed in claim 11 wherein determining the viability of the solid separator includes determining the bottleneck size above a minimum size for allowing conduction of a battery ion.

19. The method as claimed in claim 11 wherein determining the viability of the solid separator includes determining the channel dimensionality of at least 2 for allowing conduction of a battery ion.

20. The method as claimed in claim 11 wherein generating the modified tessellation by removing the edge includes removing the edge having a length greater than the distance threshold of 0.15 angstrom.
